(19) United States
(12) Patent Application Publication
(10) Pub. No.: US 2020/0252342 A1
(43) Pub. Date: Aug. 6, 2020

(54) METHOD AND DEVICE FOR DELIVERING PACKETS TO APPLICATION

(71) Applicant: Samsung Electronics Co., Ltd., Suwon-si, Gyeonggi-do (KR)

(72) Inventors: Jong-ryool KIM, Suwon-si (KR); Hyo-taek SHIM, Yongin-si (KR)

(21) Appl. No.: 15/776,258

(22) PCT Filed: Apr. 27, 2016
(86) PCT No.: PCT/KR2016/004396

§ 371 Date: May 15, 2018

(30) Foreign Application Priority Data
Dec. 7, 2015 (KR) 10-2015-0173303

(51) Int. Cl. H04L 12/825; H04L 12/801

(52) U.S. Cl. CPC H04L 47/25; H04L 47/12

(57) ABSTRACT

Provided is a method of delivering, by a device, packets to an application installed on the device the method including: obtaining information regarding a delivery mode determination condition, the information being used to determine a delivery mode of delivering the packets to the application; determining a delivery mode of delivering the packets based on the obtained information regarding the delivery mode determination condition; receiving packets to be delivered to the application through a network interface of the device; and delivering, to the application, the packets to be delivered according to the determined delivery mode.

### TECHNICAL FIELD

The present disclosure relates to a method and device for delivering packets received by the device to an application installed thereon.

### BACKGROUND ART

When packets are received through a network interface of a device, the packets may be delivered to an application. The application may provide a service by using the packets.

With regard to the packets received by the device, an application to which the packets are to be delivered and a delivery mode of packets may be determined. The device may determine a packet delivery mode according to the state of network traffic generated due to reception of packets. For example, when packets are frequently received, a polling mode, whereby packets are delivered by continuously checking the reception of packets, may be used. On the contrary, when packets are not frequently received, an interrupt mode, whereby packets are delivered by determining reception of packets if packets have already been received, may be used.

According to a method of determining the aforementioned packet delivery mode, the packet delivery mode is determined irrespective of the characteristics of the application, and thus the packets may not be optimally delivered to the application.

### DESCRIPTION OF EMBODIMENTS

### Technical Problem

Provided are a method and device for delivering packets received by the device to an application installed thereon, by determining a packet delivery mode optimized for the application to which the packets are to be delivered.

### ADVANTAGEOUS EFFECTS OF DISCLOSURE

According to an embodiment, a delivery method of packets, which is optimized for an application to which packets are to be delivered, may be determined, and packets received by a device, whereon the application is installed, may be delivered to the application according to the determined delivery method.

### BRIEF DESCRIPTION OF DRAWINGS

FIG. 1 is a block diagram of an internal structure of a device for delivering packets to an application, according to an embodiment.

FIG. 2 is a flowchart of a method of delivering packets to an application, based on a delivery mode determination condition regarding the application, according to an embodiment.

FIG. 3 is a flowchart of a method of delivering packets to an application according to an interrupt mode, according to an embodiment.

FIG. 4 is a flowchart of a method of delivering packets to an application according to a polling mode, according to an embodiment.

FIG. 5 is a flowchart of a method of delivering packets to an application according to an interrupt mode of which an interrupt throttling degree is determined, according to an embodiment.

FIG. 6 is a block diagram of an internal structure of a device, according to an embodiment.

### BEST MODE

According to an embodiment, there is provided a method of delivering, by a device, packets to an application installed on the device from among a plurality of applications, the method including: obtaining information regarding a delivery mode determination condition, the information being used to determine a delivery mode of delivering the packets to the application; determining a delivery mode of delivering the packets, based on the obtained information regarding the delivery mode determination condition; receiving packets, which are to be delivered to the application, through a network interface of the device; and delivering the packets to the application according to the determined delivery mode.

The delivery mode determination condition may include at least one of a condition regarding an amount of resource usage that is used to deliver the packets to the application and a condition regarding a latency until the packets are delivered to the application.

The delivery mode determination condition may be determined for each application to which packets are delivered, according to characteristics of service provided by the application.

The determining of the delivery mode may include determining an interrupt mode or a polling mode as the delivery mode of delivering the packets, based on the information regarding the delivery mode determination condition.

The determining of the delivery mode may include determining an interrupt throttling degree for delivering the packets according to an interrupt mode, based on the information regarding the delivery mode determination condition.

The determining of the delivery mode may include: determining at least one delivery mode that satisfies at least one of conditions included in the delivery mode determination condition; and finally determining one of the at least one determined delivery mode.

The determining of the delivery mode may include determining the delivery mode of packets to be delivered to the application, based on a history of the delivery mode determined for the application.

The determining of the delivery mode may include determining the deliver mode of the packets by predicting network traffic generated while the packets are received, based on a history of the packets that are received.

According to an embodiment, there is provided a device for delivering packets to an application installed on the device from among a plurality of applications, the device including: a controller configured to obtain information regarding a delivery mode determination condition, the information being used to determine a delivery mode of delivering the packets to the application, and determine the delivery mode based on the information regarding the delivery mode determination condition; a network interface configured to receive the packets to be delivered to the application and deliver the packets to the application according to the determined delivery mode; and a memory configured to store the application and the information regarding the delivery mode determination condition.

### MODE OF DISCLOSURE

The present disclosure will now be described more fully with reference to the accompanying drawings, in which embodiments of the disclosure are shown. In the description of the present disclosure, certain detailed explanations of the related art are omitted when it is deemed that they may unnecessarily obscure the essence of the disclosure. Like reference numerals in the drawings denote like elements.

It will be understood that the terms and words used herein should be interpreted as having a meaning that is consistent with their meaning in the context of the relevant art and will not be interpreted in an idealized or overly formal sense unless expressly so defined herein. Therefore, embodiments and the drawings included in the present specification are not intended to limit the present disclosure to particular modes of practice, and it is to be appreciated that all changes, equivalents, and substitutes that do not depart from the spirit and technical scope of the present disclosure are encompassed in the present disclosure.

Components in the drawings may be exaggerated, omitted, or simplified. Sizes of components illustrated in the drawings are not intended to illustrate actual sizes of components and are not intended to limit the present disclosure.

Throughout the specification, when a portion “includes” an element, another element may be further included, rather than excluding the existence of the other element, unless otherwise described. Also, throughout the specification, when a portion is referred to as being “connected to” another portion, the portion may be “directly connected to” or “electrically connected to” the other portion with intervening portions therebetween.

The terms used in the present specification are merely used to describe particular embodiments, and are not intended to limit the present disclosure. An expression used in the singular encompasses the expression of the plural, unless it has a clearly different meaning in the context. In the present specification, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Also, the term “unit” refers to a software or hardware component such as field-programmable gate array (FPGA) or application specific integrated circuit (ASIC) and performs certain functions. However, the “unit” is not limited thereto. The “unit” may be configured to be stored in a storage medium on which addressing may be performed or may be configured to execute one or more processors. For example, the “unit” includes components (e.g., software components, object-oriented software components, class components, and task components), processes, functions, attributes, procedures, sub-routines, segments of program codes, drivers, firmware, micro codes, circuits, data, database, data structures, tables, arrays, and variables. Components and functions provided in the “units” may be combined into a smaller number of components and “units” or separated into additional components and “units”.

One or more embodiments of the disclosure will be clearly described in detail with reference to the attached drawings so that one of ordinary skill in the art to which the present disclosure pertains may easily practice the disclosure. The present disclosure may, however, be embodied in many different forms and should not be construed as being limited to the embodiments set forth herein. In addition, portions that are irrelevant to the descriptions of the disclosure will be omitted for clarity, and like reference numerals in the drawings denote like elements.

Hereinafter, the present disclosure will be described in detail by explaining embodiments of the disclosure with reference to the attached drawings.

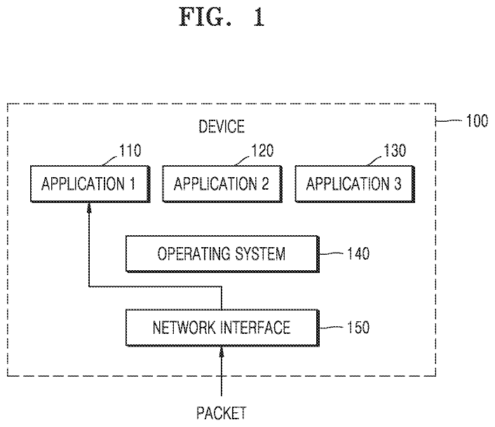

FIG. 1 is a block diagram of an internal structure of a device 100 for delivering packets to an application installed on the device 100, according to an embodiment.

Referring to FIG. 1, the device 100 for delivering packets to an application may include an application 1 110, an application 2 120, an application 3 130, an operating system 140, and a network interface 150.

Not every component of the device 100 of FIG. 1 is necessary. The device 100 may be implemented by using more or less components than the components illustrated in FIG. 1.

The device 100 according to an embodiment may be a server device capable of providing a service of the application to a client. Alternatively, the device 100 may be a terminal device that a user may use. However, the device 100 is not limited thereto. The device 100 may be one of various types of devices that receive packets from the outside via a network and deliver the received packets to an application installed on and executed by the device 100. The packets delivered to the application may be used to perform the service of the application.

Hereinafter, the aforementioned components of the device 100 will be sequentially described.

The device 100 may include at least one application that may be executed, that is, the application 1 110, the application 2 120, or the application 3 130. After the application 1 110, the application 2 120, and the application 3 130 are installed on the device 100, the application 1 110, the application 2 120, and the application 3 130 may be executed by a controller of the device 100. The application 1 110 may receive the packets that have been received from the outside through the network interface 150.

Examples of a mode of delivering packets to an application include an interrupt mode and a polling mode. However, examples of the mode are not limited thereto. A mode of delivering packets to an application may vary. According to the interrupt mode, when the network interface 150 receives the packets from the outside, the network interface 150 notifies the application to which the packets are to be delivered of the reception of the packets, and thus, the packets may be delivered to the application. According to the polling mode, the application continues to transmit, to the network interface 150, polling signals for checking whether the packets have been received, and thus, the packets may be delivered to the application.

According to the polling mode, even when the packets which are to be delivered to the application have not yet been received, the polling signals may be transmitted to the network interface 150. Therefore, when the packets are not frequently received, it may be better to use the interrupt mode than the poling mode.

Also, according to the interrupt mode, interrupt signals for notifying that the packets are received may be transmitted to the application, and in response to a response signal of the application, the packets may be delivered. Thus, the interrupt mode may further include more signals generated to deliver packets, compared to the polling mode. Therefore, when packets are frequently received, it is better to use the polling mode to deliver packets than the interrupt mode.

The packets received by the device 100 may be delivered directly to the application 1 110, the application 2 120, or the application 3 130 without passing through the operating system 140. For example, one of the application 1 110, the application 2 120, and the application 3 130 may receive the packets via a zero copy-based toolkit such as a data plane development kit (DPDK), a netmap, or openonload, without passing through the operating system 140.

The packets received by the device 100 may be classified by the zero copy-based toolkit according to each application to which each packet is to be delivered. The application may receive the packets according to a predefined mode of delivering packets. However, one or more embodiments of the present disclosure are not limited thereto. The device 100 may use various methods to deliver to the application the packets received through the network interface 150 without passing through the operating system 140. When the packets are received, the device 100 may determine an application to which the packets are to be delivered and may deliver the packets to the determined application. The device 100 may deliver the packets to the application according to a predefined mode of delivering packets.

When the packets are delivered to the application without passing through the operating system 140, the device 100 may determine modes of delivering packets differently for each application. Based on a delivery mode determination condition that is set for each application, the device 100 may determine an optimum mode of delivering packets to each application. Based on information regarding a history of packets received for a certain period of time, the device 100 may determine the mode of delivering packets for each application. The mode of delivering packets may be periodically or frequently determined for each application.

For example, the device 100 may determine the mode of delivering packets for the application 1 110 based on information regarding a history of the packets which have been delivered to the application 1 110 for a certain period of time and are received by the network interface 150.

Modes of delivering packets which are determined by the device 100 at the same point in time according to operation patterns of applications may be similar to each other. Also, amounts of network traffic which are generated due to the packets received by the device 100 at the same point in time according to the operation patterns of the applications may be similar to each other. Therefore, the device 100 may determine the mode of delivering packets to the application 1 110 based on a pattern of the mode of delivering the packets that is determined for the application 1 110 or a pattern of network traffic generated as the packets are received.

Based on a history of the mode of delivering packets that is determined for the application 1 110, the device 100 may be trained with respect to the pattern of the mode of delivering packets and may determine, for the application 1 110, the mode of delivering packets based on a training result. In addition, the device 100 may be trained with respect to the pattern of the network traffic generated due to the reception of the packets, based on a history of receiving the packets delivered to the application 1 110. The device 100 may predict network traffic that may be generated due to the reception of the packets based on a training result and may determine the mode of delivering packets for the application 1 110 based on the predicted network traffic.

After the mode of delivering packets is determined, the device 100 may deliver to the application 1 110 the packets received by the network interface 150 according to the determined mode.

The delivery mode determination condition set for each application may include at least one of a condition regarding an amount of resources used to deliver the packets to the application and a condition regarding a latency until the packets are delivered to the application.

According to the mode of delivering packets and the network traffic generated due to the reception of the packets, amounts of resources used by the device 100 to deliver the packets to the application and the latency may differ.

The latency may be a period of time until the packets received by the network interface 150 are delivered to the application. As the latency increases, the packets may be delivered to the application late.

When the packets are delivered according to the polling mode and when the packets are frequently received, the amount of resource usage may decrease, compared to the interrupt mode. However, when the packets are not frequently received, polling signals for checking whether the packets are received may be generated even when there are no packets to be delivered to the application. Therefore, when the packets are not frequently received, the amount of resource usage according to the polling mode may increase, compared to the interrupt mode.

Also, when the packets are delivered according to the polling mode, polling signals for checking whether the packets are received may be generated according to predefined polling intervals. As the polling intervals decrease, the amount of resource usage may increase, but the latency may decrease. On the contrary, when the polling intervals increases, the amount of resource usage may decrease, but the latency may increase.

According to the interrupt mode, when the packets are received, interrupt signals for notifying the application of the reception of the packets may be transmitted to the application. When an interrupt throttling degree is set and when the packets are received by as many as the interrupt throttling degree, the interrupt signals may be transmitted to the application. However, when the packets are not frequently received, the latency until the packets received by the network interface 150 first may increase according to the interrupt throttling degree. Based on the condition regarding the latency of the delivery mode determination condition of the application, the device 100 may set the interrupt throttling degree to prevent the latency of the packets from becoming longer than the latency of the delivery mode determination condition.

Therefore, the device 100 may determine the mode of delivering packets for each application so as to satisfy at least one or all of the conditions regarding the amount of resource usage and latency that are set for each application. When the interrupt mode is determined as the mode of delivering packets, the device 100 may also determine the interrupt throttling degree based on the above conditions. In addition, when the polling mode is determined as the mode of delivering packets, the device 100 may also determine the polling intervals based on the above conditions.

The device 100 may determine at least one mode of delivering packets that may satisfy at least one or all of the conditions regarding the amount of resource usage and latency that are set for each application. For example, the device 100 may determine at least one of one or more polling modes having different polling intervals and one or more interrupt modes having different interrupt throttling degrees, as the mode of delivering packets that may satisfy at least one or all of the above conditions. Alternatively, the device 100 may determine polling intervals in a certain range or interrupt throttling degrees in a certain range as a condition for delivering packets that may satisfy at least one or all of the above conditions.

The device 100 may finally determine an optimum mode of delivering packets from among the at least one mode of delivering packets. Alternatively, within the determined polling intervals in the certain range or the determined interrupt throttling degrees in the certain range, the device 100 may finally determine the most appropriate mode of delivering packets. For example, the device 100 may finally determine a mode of delivering packets having the least amount of resource usage or the shortest latency from among the at least one mode of delivering packets. Therefore, the delivery mode determination condition that is set for each application may further include information regarding whether which condition is to be considered when the mode of delivering packets is finally determined.

The delivery mode determination condition may be determined according to characteristics of the service provided by the application. For example, when a real-time property of the packets is important, a preset latency that is included in the delivery mode determination condition may decrease. The importance of the real-time property of the packets may be determined according to the service provided by the application. For example, in the case of a service for providing replay broadcast or real-time broadcast to a client or a user in real time, the importance of the real-time property of the packets increases, and thus the latency may set to be short.

Also, an amount of resource usage that is set for an application for which a limited amount of resource usage is required may decrease. For example, when the amount of resource usage of the application is limited according to settings, the defined amount of resource usage that is included in the delivery mode determination condition may be set based on the limited amount of resource usage.

According to the above embodiment, the packets may be delivered to the application without passing through the operating system 140. According to another embodiment, the packets received by the device 100 through the network interface 150 may be delivered to the application 1 110, the application 2 120, and the application 3 130 by the operating system 140. When the packets are received by the device 100, the operating system 140 may determine an application to which the received packets are to be delivered, and may deliver the packets to the determined application.

However, when the packets are delivered to the application by the operating system 140, the operating system 140 may deliver the packets to the application according to a mode of delivering packets that is determined irrespective of an application to which the packets are to be delivered. Therefore, when the packets are delivered to the application by the operating system 140, it may be difficult to deliver the packets to the application according to the mode of delivering packets that is optimized for each application.

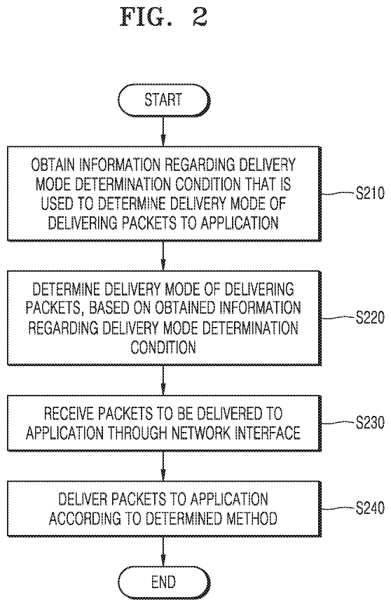

FIG. 2 is a flowchart of a method of delivering packets to an application on the device 100, based on a delivery mode determination condition of the application, according to an embodiment.

Referring to FIG. 2, in operation S210, the device 100 may obtain information regarding the delivery mode determination condition that is used to determine the mode of delivering the packets to the application. Before the packets are received, the device 100 may determine the mode of delivering the packets in advance. In order to determine a mode of delivering packets that is optimized for each application to which the packets are to be delivered, the device 100 may determine the mode of delivering packets for each application based on information regarding a delivery mode determination condition that is set for each application. The delivery mode determination condition may include a value that is set by the user or initially set.

In operation S220, the device 100 may determine the mode of delivering packets based on the information regarding the delivery mode determination condition which is obtained in operation S210. For example, the device 100 may obtain a latency and an amount of resource usage according to each mode of delivering packets, based on information regarding a history of packets that were received at a previous point in time with respect to a point in time when the mode of delivering packets is determined. The packets that are recorded in the history may be packets delivered to the application for which the mode of delivering packets is to be determined. The mode of delivering packets which does not satisfy the delivery mode determination condition of the application may be excluded. When there are multiple modes of delivering packets, the device 100 may finally determine an optimum mode of delivering packets from among the modes of delivering packets.

In operation S230, the device 100 may receive the packets to be delivered to the application through the network interface. In operation S240, the device 100 may deliver the packets to the application according to the mode of delivering packets that is determined in operation S220. The device 100 may determine the packets to be delivered to the application from among the received packets and may deliver the packets to the application according to the mode of delivering packets that is determined in operation S220.

When the packets are delivered according to the polling mode and when polling signals for checking whether the packets are received are generated, the device 100 may check whether packets to be delivered to the application may exist. When packets to be delivered to the application exist, the device 100 may deliver the packets to the application. When the packets are delivered according to the interrupt mode and when packets to be delivered to the application exist, the device 100 may deliver interrupt signals of informing that the packets are delivered to the application. In response to a packet delivering request from the application, the device 100 may deliver the packets to the application.

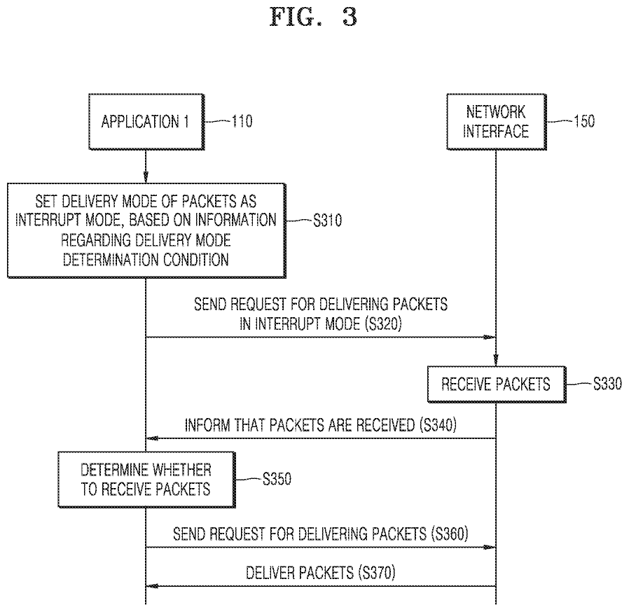

Hereinafter, referring to FIGS. 3 to 5, a method of delivering packets to an application on a device according to each mode of delivering packets will be described in detail.

FIG. 3 is a flowchart of a method of delivering packets to the application 1 110 according to the interrupt mode, according to an embodiment.

Referring to FIG. 3, in operation S310, based on the information regarding the delivery mode determination condition regarding the application 1 110, the mode of delivering the packets to the application 1 110 may be set as the interrupt mode. Based on information regarding a history of packets received for a certain period of time, the application 1 110 may determine at least one mode of delivering packets that satisfies the delivery mode determination condition, and then may finally determine an optimum mode of delivering packets.

In operation S320, the application 1 110 may send, to the network interface 150, a request for delivering the packets to the application 1 110 according to the interrupt mode. Before the mode of delivering packets to the application 1 110 is newly determined, the network interface 150 may deliver the packets to the application 1 110 according to the interrupt mode after operation S320.

In operation S330, the network interface 150 determines that the packets to be delivered to the application 1 110 are received. In operation S340, the interrupt signals for informing that the packets are received may be transmitted to the application 1 110.

When the interrupt signals for informing that the packets are received are received from the network interface 150, the application 1 110 may determine whether to receive the packets from the network interface 150 in operation S350.

In operation S360, the application 1 110 may send a request for delivering the packets to the network interface 150 according to the determination made in operation S350. In operation S370, the network interface 150 may deliver, to the application 1 110, the packets received in operation S330, in response to the request for delivering the packets to the application 1 110.

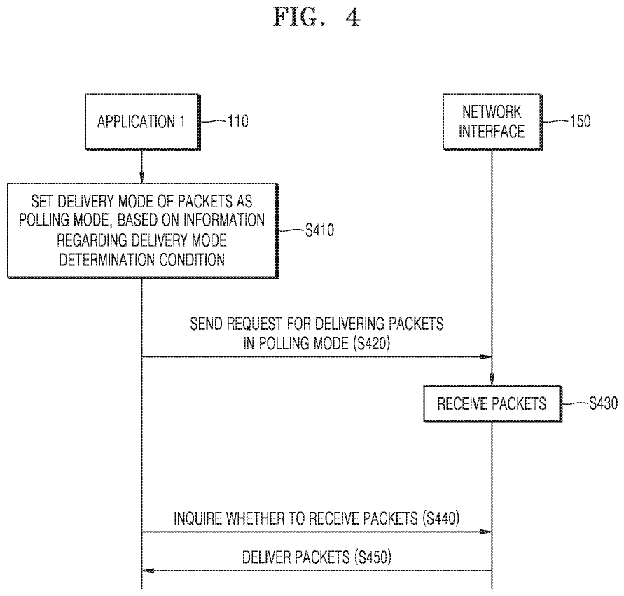

FIG. 4 is a flowchart of a method of delivering packets to an application according to the polling mode, according to an embodiment.

Referring to FIG. 4, in operation S410, based on the information regarding the delivery mode determination condition to the application 1 110, the mode of delivering packets to the application 1 110 may be set as the polling mode. Based on information regarding a history of packets received for a certain period of time, the application 1 110 may determine at least one mode of delivering packets that satisfies the delivery mode determination condition, and then may finally determine an optimum mode of delivering packets.

In operation S420, the application 1 110 may send, to the network interface 150, the request for delivering the packets to the application 1 110 according to the polling mode. Before the mode of delivering packets to the application 1 110 is newly determined, the network interface 150 may deliver the packets to the application 1 110 according to the polling mode after operation S420.

In operation S430, the network interface 150 may determine that the packets to be delivered to the application 1 110 are received.

In operation S440, the application 1 110 may transmit, to the network interface 150, polling signals for inquiring whether the packets, which are to be delivered to the application 1 110, are received according to the polling mode. In operation S450, the network interface 150 may deliver the packets received in operation S430 to the application 1 110, in response to the polling signals from the application 1 110.

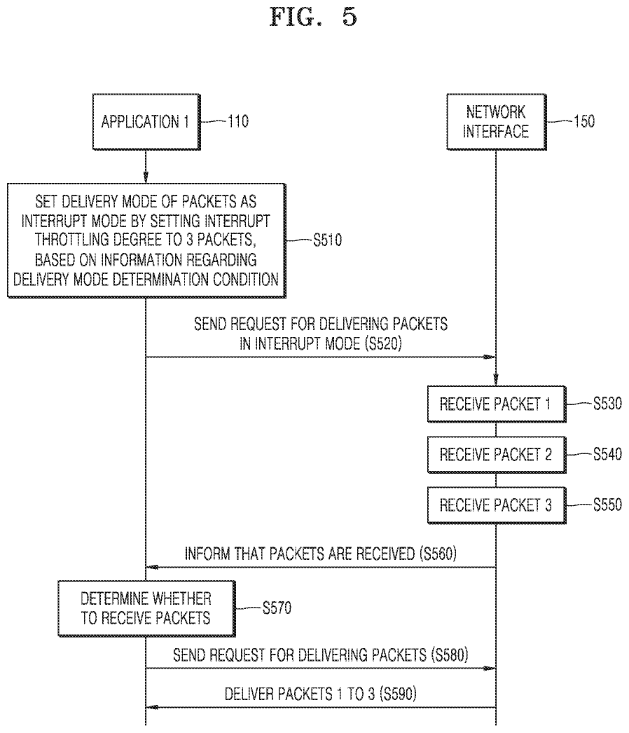

FIG. 5 is a flowchart of a method of delivering packets to the application 1 110 according to an interrupt mode of which an interrupt throttling degree is determined, according to an embodiment.

Referring to FIG. 5, in operation S510, based on the information regarding the delivery mode determination condition to the application 1 110, the mode of delivering the packets to the application 1 110 may be set as an interrupt mode of which an interrupt throttling degree is 3 packets. The application 1 110 may determine at least one mode of delivering packets that satisfies the delivery mode determination condition, based on the history of the packets received for a certain period of time, and then may finally determine an optimum mode of delivering packets. The at least one mode, which may be determined based on the information regarding the history of the packets received for a certain period of time, may include at least one of one or more polling modes having different polling intervals and one or more interrupt modes having different interrupt throttling degrees.

In operation S520, the application 1 110 may send, to the network interface 150, a request for delivering the packets to the application 1 110 according to the interrupt mode. In operation S520, the application 1 110 may also transmit, to the network interface 150, information regarding the interrupt throttling degree determined in operation S510. Before the mode of delivering the packets to the application 1 110 is newly determined, the network interface 150 may deliver the packets to the application 1 110 according to the interrupt mode of which the interrupt throttling degree is 3 packets after operation S520.

In operations S530 to S550, when it is determined that the number of packets to be delivered to the application 1 110 is equal to the interrupt throttling degree, that is, three, in operation S560, the network interface 150 may transmit, to the application 110, the interrupt signals for informing that the packets are received.

When receiving, from the network interface 150, the interrupt signals for informing that the number of packets is equal to the interrupt throttling degree, the application 1 110 may determine whether to deliver, to the application 1 110, the packets received by the network interface 150, in operation S570.

In operation S580, the application 1 110 may send, to the network interface 150, a request for delivering the packets according to the determination made in operation S570. In operation S590, the network interface 150 may deliver the three packets, which are received in operations S530 to S550, to the application 1 110 in response to the request from the application 1 110.

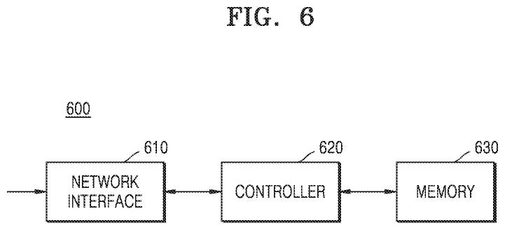

FIG. 6 is a block diagram of an internal structure of a device 600, according to an embodiment.

Referring to FIG. 6, the device 600 may include a network interface 610, a controller 620, and a memory 630.

The network interface 610 may receive packets to be delivered to an application installed on the device 600 via a network. The network interface 610 may deliver the received packet to the application according to a mode of delivering packets which is determined for each application.

The controller 620 may determine the mode of delivering the packets to the application, based on information regarding a delivery mode determination condition that is used to determine the mode of delivering the packets to the application. The controller 620 may determine at least one mode of delivering packets that satisfies the delivery mode determination condition, based on information regarding a history of packets received for a certain period of time. The controller 620 may finally determine a mode of delivering packets as the optimum mode from among the at least one method as the mode of delivering packets. The at least one mode, which may be determined based on the information regarding the history of the packets, may include, for example, at least one of one or more polling modes having different polling intervals and one or more interrupt modes having different interrupt throttling degrees.

The memory 630 may store various applications and data of the device 600. The memory 630 may store the applications and information regarding delivery mode determination conditions to the applications.

According to an embodiment, a mode of delivering packets that is optimized for the application, to which the packets are delivered, may be determined, and the packets, which are delivered from the device according to the determined mode, may be delivered to the application.

The methods according to some embodiments may be embodied as program commands executable by various computer devices and may be recorded on a non-transitory computer-readable medium. The non-transitory computer-readable medium may include one or a combination of program commands, data files, and data structures. The program commands recorded on the non-transitory computer-readable medium may be specially designed or configured for the present disclosure or may be used by one of ordinary skill in the computer software art. Examples of the non-transitory computer-readable medium include magnetic media such as hard disks, floppy disks, and magnetic tapes, optical media such as CD-ROMs and DVDs, magneto-optical media such as floptical disks, and hardware components (e.g., read-only memory (ROM), random-access memory (RAM), flash memory, etc.) specially designed to store and execute program commands. Examples of the program commands include machine language codes generated by a complier as well as high-level language codes executable by a computer by using an interpreter.

Although the present disclosure has been described by focusing on novel features of the present disclosure applied to one or more embodiments, it will be understood by one of ordinary skill in the art that various substitutions, amendments, or modifications may be made to the one or more embodiments of the present disclosure without departing from the spirit and scope of the present disclosure. Therefore, the scope of the disclosure is defined not by the detailed description of the disclosure but by the appended claims, and all differences within the scope will be construed as being included in the present disclosure.

1. A method of delivering, by a device, packets to an application installed on the device from among a plurality of applications, the method comprising:
obtaining information regarding a delivery mode determination condition, the information being used to determine a delivery mode of delivering the packets to the application;
determining a delivery mode of delivering the packets, based on the obtained information regarding the delivery mode determination condition;
receiving packets, which are to be delivered to the application, through a network interface of the device; and
delivering the packets to the application according to the determined delivery mode.

2. The method of claim 1, wherein the delivery mode determination condition comprises at least one of a condition regarding an amount of resource usage that is used to deliver the packets to the application and a condition regarding a latency until the packets are delivered to the application.

3. The method of claim 1, wherein the delivery mode determination condition is determined for each application to which packets are delivered, according to characteristics of service provided by the application.

4. The method of claim 1, wherein the determining of the delivery mode comprises determining an interrupt mode or a polling mode as the delivery mode of delivering the packets, based on the information regarding the delivery mode determination condition.

5. The method of claim 1, wherein the determining of the delivery mode comprises determining an interrupt throttling degree for delivering the packets according to an interrupt mode, based on the information regarding the delivery mode determination condition.

6. The method of claim 1, wherein the determining of the delivery mode comprises:
determining at least one delivery mode that satisfies at least one of conditions comprised in the delivery mode determination condition; and
finally determining one of the at least one determined delivery mode.

7. The method of claim 1, wherein the determining of the delivery mode comprises determining the delivery mode of packets to be delivered to the application, based on a history of the delivery mode determined for the application.

8. The method of claim 1, wherein the determining of the delivery mode comprises determining the deliver mode of the packets by predicting network traffic generated while the packets are received, based on a history of the packets that are received.

9. A device for delivering packets to an application installed on the device from among a plurality of applications, the device comprising:
a controller configured to obtain information regarding a delivery mode determination condition, the information being used to determine a delivery mode of delivering the packets to the application, and determine the delivery mode based on the information regarding the delivery mode determination condition;
a network interface configured to receive the packets to be delivered to the application and deliver the packets to the application according to the determined delivery mode; and
a memory configured to store the application and the information regarding the delivery mode determination condition.

10. The device of claim 9, wherein the delivery mode determination condition comprises at least one of a condition regarding an amount of resource usage that is used to deliver the packets to the application and a condition regarding a latency until the packets are delivered to the application.

11. The device of claim 9, wherein the delivery mode determination condition is determined for each application to which packets are delivered, according to characteristics of service provided by the application.

12. The device of claim 9, wherein the controller is further configured to determine an interrupt mode or a polling mode as the delivery mode of delivering the packets, based on the information regarding the delivery mode determination condition.

13. The device of claim 9, wherein the controller is further configured to determine at least one delivery mode satisfying at least one of conditions comprised in the delivery mode determination condition, and to finally determine one of the at least one determined delivery mode.

14. The device of claim 9, wherein the controller is further configured to determine the delivery mode of packets to be delivered to the application, based on a history of the delivery mode determined for the application.

15. The device of claim 9, wherein the controller is further configured to determine the delivery mode by predicting network traffic generated while the packets are received based on a history of the packets that are received.
